(19) United States
(12) Patent Application Publication
(10) Pub. No.: US 2026/0159102 A1
(43) Pub. Date: Jun. 11, 2026

(54) METHOD FOR MANAGING VEHICLE RISK AND SERVER THEREFOR

(71) Applicant: HL MANDO CORPORATION, Gyeonggi-do (KR)

(72) Inventors: Yongwoo LEE, Gyeonggi-do (KR); Hoondow JANG, Gyeonggi-do (KR); Jaehyeon LIM, Gyeonggi-do (KR); Dasol KIM, Gyeonggi-do (KR)

(21) Appl. No.: 19/411,138

(22) Filed: Dec. 5, 2025

(30) Foreign Application Priority Data
Dec. 6, 2024 (KR) 10-2024-0180767
Dec. 1, 2025 (KR) 10-2025-0187543

(51) Int. Cl. B60W 50/02; G07C 5/00

(52) U.S. Cl. CPC B60W 50/0225; B60W 50/0205; G07C 5/008

(57) ABSTRACT

A vehicle risk management method performed by a server, the method comprises identifying a plurality of function elements of the vehicle the have interrelationships, deriving a target hazard scenario, which is a subject of risk assessment, based on at least one operational situation element, determining a safety level based on an exposure, a severity, and a controllability of a hazard situation for the target hazard scenario, and establishing a safety goal based on the target hazard scenario and the safety level.

### CROSS-REFERENCE TO RELATED APPLICATION

This application claims the benefit of Korean Patent Application Nos. 10-2024-0180767, filed on Dec. 6, 2024 and 10-2025-0187543, filed on Dec. 1, 2025 in the Korean Intellectual Property Office, the disclosure of which is incorporated herein by reference.

### BACKGROUND

### 1. Field

The disclosed invention relates to a vehicle risk management method and a server for performing the same.

### 2. Description of the Related Art

Among the various fields of the automobile industry, the most innovative and rapidly developing area since the 2000s has been the field of electrical and electronic systems. In particular, controllers that govern vehicle behavior have significantly contributed to road traffic safety by providing drivers with a more stable driving experience through more precise control enabled by advancements in vehicle semiconductors and embedded software. In addition, by offering convenience features for drivers, the marketability of vehicles has been further enhanced. Going beyond controlling engines or brakes, vehicles now provide smart keys, navigation systems, and various infotainment systems. Accordingly, multiple controllers in a vehicle communicate and exchange information with each other through the in-vehicle network.

Along with these advancements, the complexity of vehicle systems and the importance of safety continue to increase, but high-risk accidents caused by compound failures of electrical and electronic components intended to ensure software invisibility and availability are still being continuously reported.

To prevent such incidents, ISO 26262 was first published in 2011, revised in 2018, and has since been widely applied.

ISO 26262 is an international standard that addresses functional safety of electrical and electronic systems within a vehicle, prescribing a development process intended to prevent failures or malfunctions in such systems from leading to accidents.

In addition, ISO 26262 focuses on quality assurance by enabling more accurate system design, precise analysis, and thorough verification and validation to ensure the safety of defined data, systems, and subsystems.

ISO 26262 requires a systematic approach that identifies safety requirements from the early stages of vehicle system development and ensures that these safety requirements are satisfied throughout the design, verification, and maintenance phases. For example, ISO 26262 mandates the performance of Hazard Analysis & Risk Assessment (HARA) to identify and assess vehicle-level hazards arising from product failures.

In the case of HARA, many companies have traditionally created and managed documents using Excel-based forms, but to date, no software tool specialized for HARA has been developed.

HARA derives hazard events by considering operational situations and/or malfunctions, and as the number of hazard events increases, the processing time for Excel VBA (Visual Basic for Applications) becomes longer, which is a disadvantage.

### SUMMARY

The problem to be solved by the present invention is to provide a vehicle risk-management method and a server therefor that are capable of integrating Hazard Analysis & Risk Assessment (HARA) and Fail-Safe Management (FSM).

The problem to be solved by the present invention is to provide a vehicle risk-management method and a server therefor that are capable of integrating Hazard Analysis & Risk Assessment (HARA) and Fail-Safe Management (FSM).

Another problem to be solved by the present invention is to provide a vehicle risk-management method and a server therefor that improve the integrated management and reusability of data generated and used during the HARA analysis process, and that manage common data required for hazard analysis in a standardized format.

Another problem to be solved by the present invention is to provide a vehicle risk-management method and a server therefor that automatically output HARA execution results as various types of reports or documents depending on the intended purpose.

The technical problem that the present invention aims to solve is to provide a vehicle risk management method and a server capable of outputting results that conform to formats suggested by ISO for DTC (Diagnostic Trouble Code), such as GMRDB, or OEM-specific templates when needed, by using an integrated database to generate output matching the required template.

According to an aspect of the disclosed invention, a vehicle risk management method may include identifying a plurality of function elements of the vehicle that have interrelationships; deriving a target hazard scenario serving as a subject of risk assessment based on at least one operational situation element; determining a safety level based on an exposure, a severity, and a controllability of a hazard situation for the target hazard scenario; and establishing a safety goal based on the target hazard scenario and the safety level.

The plurality of function elements may include at least one of a function of the vehicle, a malfunction of the function, and a hazardous state that may occur due to the malfunction.

The target hazard scenario may be derived based on a driving situation obtained by combining the at least one operational situation element related to an operating mode, a driving situation, and an environmental condition of the vehicle, and excluding contradictory combinations among the combined operational situation elements.

The target hazard scenario may be defined as a hazardous event formed by a combination of the operational situation and the hazardous state.

The safety level may be determined by evaluating the exposure, the severity, and the controllability of the hazard situation according to predetermined evaluation criteria, and combining evaluation results of the exposure, the severity, and the controllability.

The method may further comprise establishing safety mechanisms to achieve the safety goal of the vehicle, wherein establishing the safety mechanisms comprises: defining a failure condition of a function of the vehicle, setting parameters used to determine the failure of the function, and storing the parameters in a database; and extracting diagnostic information and response-related information used to determine whether the function failure occurs based on the parameters, and storing the diagnostic information and the response-related information in the database as risk-assessment input data.

As a technical means for achieving the above-described technical objectives, a computer program according to one aspect of the present invention is stored on a medium to execute the vehicle risk management method described above by using a computing device.

A server according to one aspect of the disclosed invention may include a database in which a plurality of data for vehicle risk management are stored, a communication module configured to communicate with an external device, and a processor electrically or communicatively connected to the database and the communication module. The processor may be configured to identify a plurality of function elements of the vehicle having interrelationships, derive a target hazard scenario that is subject to risk evaluation based on at least one operational situation element, determine a safety level based on the exposure, severity, and controllability of a hazard situation for the target hazard scenario, and establish a safety goal based on the target hazard scenario and the safety level.

The plurality of function elements may include at least one of a function of the vehicle, a malfunction of the function, and a hazardous state that may occur due to the malfunction.

The target hazard scenario may be derived by combining the at least one operational situation element regarding an operating mode, a driving situation, and an environmental condition of the vehicle, and excluding contradictory combinations among the combined operational situation elements.

The target hazard scenario may be defined as a hazardous event formed by combining the operational situation and the hazardous state.

The safety level may be determined by evaluating the exposure, severity, and controllability of the hazard situation based on predetermined evaluation criteria, and combining results of the evaluations of the exposure, the severity, and the controllability.

The processor may be configured to establish a safety mechanism for achieving the safety goal of the vehicle, and to define a functional failure condition of the vehicle, set a parameter used for determining the functional failure, store the parameter in the database, extract diagnostic information and response-related information used for determining whether a functional failure of the vehicle has occurred based on the parameter, and store the diagnostic information and the response-related information in the database as risk-assessment input data, thereby establishing the safety mechanism.

The processor may be configured such that, for identical or similar target hazard scenarios, results of applying the safety mechanism are matched with each other and linked or managed in the database.

It is an objective of certain embodiments of the present invention to address, alleviate, or at least partially resolve at least one of the problems and/or disadvantages associated with the related art. Certain embodiments are intended to provide at least one of the advantages described below.

In one aspect, a vehicle risk-management method and a server according to the disclosed embodiments enable more systematic and efficient management of risks caused by functional malfunctions by performing a hazard analysis and risk assessment (HARA) procedure for the vehicle.

According to the present invention, a series of processes such as hazard identification, derivation of hazardous events, establishment of safety goals, and determination of safety levels can be automated through a software tool that supports the execution of the HARA procedure, thereby ensuring consistency and reliability of HARA results.

According to the present invention, common data generated during the execution of HARA can be managed in a standardized, integrated database format, which improves the reusability and traceability of data required for hazard analysis.

According to the present invention, HARA result data can be output in various templates depending on the intended purpose, thereby enabling the generation of result reports including safety goals, hazardous events, safety mechanisms, and the like.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating a system for vehicle risk management according to an embodiment;

FIG. 2 is a diagram illustrating a procedure and relational flow of safety hazard analysis and risk assessment according to an embodiment;

FIG. 3 is a diagram exemplarily illustrating safety hazard analysis and risk-assessment data according to the embodiment of FIG. 2;

FIG. 4 is a block diagram of a vehicle risk management system according to an embodiment;

FIG. 5 is a flowchart illustrating a control operation procedure of a server according to an embodiment; and

FIG. 6 is a flowchart illustrating a control procedure of a server for achieving a safety goal of a vehicle according to an embodiment.

### DETAILED DESCRIPTION

Throughout the specification, the same reference numerals refer to the same components. The specification does not describe every element of the embodiments, and general or overlapping content within the technical field of the disclosed invention is omitted. The terms “unit, module, member, block” used in the specification may be implemented in software or hardware. Depending on the embodiments, multiple “units, modules, members, blocks” may be implemented as a single component, or one “unit, module, member, block” may include multiple components.

Throughout the specification, when a part is described as being “connected” to another part, this includes not only cases where they are directly connected but also cases where they are indirectly connected, and indirect connection includes connection via a wireless communication network.

In addition, when a part is described as “including” an element, this means that, unless explicitly stated otherwise, the part may include additional elements rather than excluding other elements.

The terms first, second, and so forth are used solely to distinguish one component from another and do not limit the components by these terms.

Singular expressions include plural forms unless the context clearly indicates otherwise.

Reference numerals for steps are used for convenience of description and do not indicate the order of the steps. Unless the context explicitly requires a particular sequence, the steps may be performed in an order different from that described.

Hazard Analysis and Risk Assessment (HARA) is a procedure for systematically identifying hazardous situations that may occur due to functional malfunctions of a vehicle system and for evaluating the severity, exposure, and controllability of each hazard in order to establish safety goals. The HARA process according to the present invention focuses on analyzing potential hazards at the system level in advance and ensuring safety by comprehensively considering structural characteristics of the vehicle system, operational environments, and interactions among functions.

As a preliminary activity for performing HARA, an item definition may be prepared. The Item Definition specifies the functional and physical characteristics of the vehicle system to be analyzed, as well as the boundary conditions of the system, and is used as fundamental reference material throughout the HARA procedure. The Item Definition may include the following items.

For example, the boundary of the item may define the scope influenced by the system and the interface regions with other systems. The operational environment may include external environmental factors such as road conditions, climate conditions, and driving modes in which the system is actually operated. The regulatory requirements may describe safety standards and legal requirements that the system must comply with. The functional description may specify the main functions performed by the system and their operational conditions.

Defining the system boundaries and interfaces clearly is essential for the HARA procedure. This is because it allows analyzing the potential influence range of a malfunction in a specific function and identifying cascading hazards that may occur through interactions with other functions. For example, in a vehicle system in which braking and steering functions operate in an interlinked manner, a malfunction in one function may directly affect the safety of the other function. Therefore, the boundary and data flow between these functions must be clearly defined.

In addition, various operating modes and environmental conditions of the vehicle significantly affect both the likelihood and severity of hazard occurrence. For example, a malfunction occurring during highway driving may lead to far more severe consequences than the same malfunction occurring during low-speed driving.

Likewise, in adverse weather conditions such as snow, rain, or ice, the normal operability of braking, steering, and acceleration functions may be reduced.

Accordingly, HARA needs to quantitatively evaluate the frequency of hazard occurrence and controllability by taking such environmental conditions into account. The core procedure of HARA is to derive hazardous events from functional malfunctions of the system and to evaluate the impact of such events on the vehicle, occupants, and surrounding objects when they actually occur. For this purpose, it is essential to clearly understand the design intent of the product, the intended behavior of each function (normal operation of the function), the means for realizing the function (hardware and software components), and the performance targets required for the function to operate.

In addition, HARA is a procedure for evaluating hazards that may arise at the vehicle level as a result of functional malfunctions, regardless of the underlying causes of the malfunctions. Therefore, when malfunctions occur in various functions, including cybersecurity functions, causing symptoms such as failure of control signal transmission or degradation of communication, such malfunctions may be defined as independent hazardous events within HARA. The subsequent identification of the specific causes of the malfunctions and the establishment of corresponding mitigation measures may then be performed through separate analysis procedures such as TARA.

Consequently, the HARA procedure according to the present invention can systematically identify risks caused by functional malfunctions of the vehicle system in advance, and evaluate their impact range and controllability, thereby providing a basis for establishing the Safety Goal.

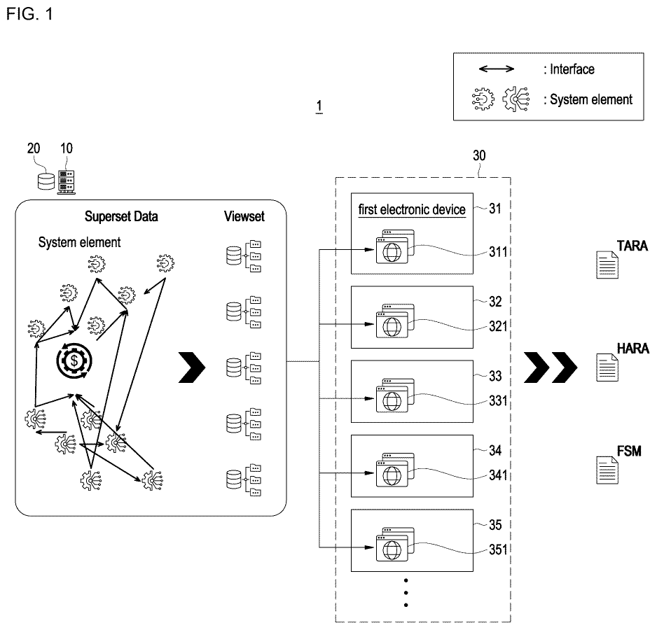

Hereinafter, the operational principles and exemplary embodiments of the disclosed invention will be described with reference to the accompanying drawings. FIG. 1 is a diagram illustrating a system for vehicle risk management according to an embodiment.

Referring to FIG. 1, the vehicle risk integrated management system 1 may include a server 10 and one or more clients 30, for example, first through fifth electronic devices 31, 32, 33, 34, and 35.

The server 10 may manage HARA documents and provide a web-based service that enables an assessment of hazard elements associated with vehicle risk.

The server 10 may store pre-designated and registered assets, functions, system elements of a vehicle, and interface information (also referred to as connection information).

The server 10 may include a database 20, and the database 20 may store assets, functions, system elements of the vehicle, and interface information.

The assets may be one or more and may include hardware and software configurations of the vehicle. They may be additionally registered or deleted. For example, the assets may include vehicle data assets, communication assets, control assets, hardware assets, software assets, authentication and security assets, and user interface assets.

The functions may be one or more and may represent the services provided to the user by the vehicle or its configuration (hardware and/or software).

The system elements may be one or more and may include hardware and/or software components of the vehicle.

The interface information may include information representing the connection relationships between the vehicle's assets and/or functions and the system elements.

The server 10 may structure text-based data and interconnect each piece of data (also referred to as information), and may organize the relationships and structured information of the interconnected data into viewsets. The server may then transmit the resulting data to electronic devices 31, 32, 33, 34, and 35.

For example, the server 10 may structure each text-based data item regarding assets, functions, and/or system elements and may organize the relationships and structured information of each text-based data into a viewset based on interface information, then transmit it to electronic devices 31, 32, 33, 34, and 35.

The server 10 may generate and output HARA output data based on asset information, function information, system element information, and/or interface information in response to information (also referred to as data) received from the electronic devices 31, 32, 33, 34, and 35.

For example, the server 10, in response to receiving asset information or function information together with additional user input data (also referred to as user input information) from an electronic device 31, 32, 33, 34, and 35 that has received data provided by a viewset, may generate HARA output data corresponding to the relevant asset or function and transmit the generated HARA output data to the corresponding electronic device 31, 32, 33, 34, and 35.

HARA is for ensuring the functional safety of a vehicle, evaluating potential hazards that may occur under various operating conditions, determining the top-level safety goals, and based on these goals, determining the Automotive Safety Integrity Level (ASIL). In the process of determining the ASIL, various operating conditions may be parameterized and utilized.

The FSM document may include information regarding safety mechanisms that are identified through HARA and derived through multiple subsequent processes.

Meanwhile, the server 10 may have the following conditions predesignated and stored regarding data usage, thereby ensuring the integrity of working data. <Conditions>
1. General users among the predefined users cannot enter data.
2. General users cannot write any data other than the data already entered.
3. Only a master user with write permission can enter data.

The server 10 may store data-connection information in advance. Accordingly, when specific information is selected by an electronic device 31, 32, 33, 34, or 35, the connected information may automatically be provided and displayed on that electronic device. Alternatively, all properties of the table linked to the selected information may be provided and displayed on the electronic device 31, 32, 33, 34, or 35, and the user of that electronic device may directly select the properties.

Additionally, the server 10 may store information requiring calculation and formulas predesignated to be associated with such information. For information requiring calculation, the server may automatically compute the result using the stored formulas and provide and display the result on the electronic devices 31, 32, 33, 34, and 35.

The server 10 may provide an approval service.

For example, the server 10 may provide an approval service to confirm that finalized information has no further changes after review and inspection between a general user and a master user.

Once the approval process is completed, the corresponding information (for example, an approved viewset) cannot be modified. If changes are needed, an approval request to unlock the data must be submitted.

The server 10 may provide a mailing service.

As a notification function, a mailing service for at least one piece of information may be predesignated in the server 10, and the server may provide the mailing service through communication with a predesignated mail server.

The server 10 may perform data visualization. The server 10 may visualize analytical information such as functional analysis and fault analysis through a structure tree and provide it to the electronic devices 31, 32, 33, 34, and 35.

The server 10 may set and store different user permissions for each user.

For example, the users may include administrators, master users, general users, and associate users. Each user may be distinguished by a user ID (Identifier).

The administrator may have permissions enabling the execution of all possible user activities. For example, the administrator may be able to register or delete users, modify user permissions, and manage data modification. The administrator may also input, edit, and delete bulk data from the administrator page.

In addition, the administrator may perform a rollback operation, which cancels ongoing transactions and restores modified data to its original state. The administrator may also modify the dashboard that appears as the first screen upon login.

A master user may have permissions set to allow reading or modifying data within the assigned project. Depending on the project, the master user's data viewing or editing rights may be restricted, and delete permissions may not be granted. The master user may also be granted separate permissions to review viewsets created by general users.

A general user may have permissions to view and modify data within the assigned project. However, in projects where permissions are not granted, the general user's ability to view or modify data may be restricted, and delete permissions may not be granted. The general user may also be given separate permissions to review viewsets created by the master user.

An associate user may have permissions limited to reading and exporting viewsets. For example, the associate user may be permitted only to read and export viewsets and may not perform any other functions.

For example, the server 10 may set and store a predefined permission configuration for each user type, as shown in Table 1.

TABLE 1

| User Type | User Permissions |
|---|---|
| Administrator | Read, Write, Modify, Clear, Import, |
| | Export, Submit, and Approval |
| Master User | Read, Modify (limited to the master database), |
| | Export, and Approval |
| General User | Read, Modify, Export, and Approval |
| Associate User | Read and Export |

In Table 1, “Read” means that the user can read data from projects for which permissions have been granted.

“Write” means that the user can add new entries to the data of a project for which write permission has been granted. However, according to the pre defined settings, data may be added only to the “Superset.”

“Modify” means that the user can change existing data in a project for which modification permission has been granted. For example, the user may select and change data through a dropdown box among the graphical user interface (GUI) elements displayed on the screen of the electronic devices 31, 32, 33, 34, and 35.

“Clear” means that the user can delete data, including cases where data inside a Superset project is deleted.

“Import” means that data can be loaded into the Superset project through a file in a predefined format, such as an Excel file or a CSV file.

“Export” means that the contents of a viewset of a project for which per mission has been granted can be output or saved in a predefined format, such as Excel, Word, or PDF.

“Submit” means that, after completing the evaluation for HARA, the user may submit the corresponding viewset to request approval. For example, when a Functional Safety activity is completed, the viewset for that activity may be submitted for approval.

“Approval” means that the evaluated HARA viewset can be reviewed an d approved.

Each of the electronic devices 31, 32, 33, 34, and 35 may receive web-based services from the server 10. A web browser 311, 321, 331, 341, and 351 may be installed on each electronic device, and through the respective web browser, the user may access and use the web-based services of the server 10.

Each of the electronic devices 31, 32, 33, 34, and 35 may display screens corresponding to the web-based services of the server 10 and, through us er input, may select items for generating HARA or FSM documents corresponding to the assets or functions of the vehicle, and transmit the selected data to the server 10.

Additionally, each of the electronic devices 31, 32, 33, 34, and 35 may receive HARA and/or FSM output data related to vehicle assets or functions from the server 10 and display it on the screen or output HARA, TARA, and/or F SM as output data.

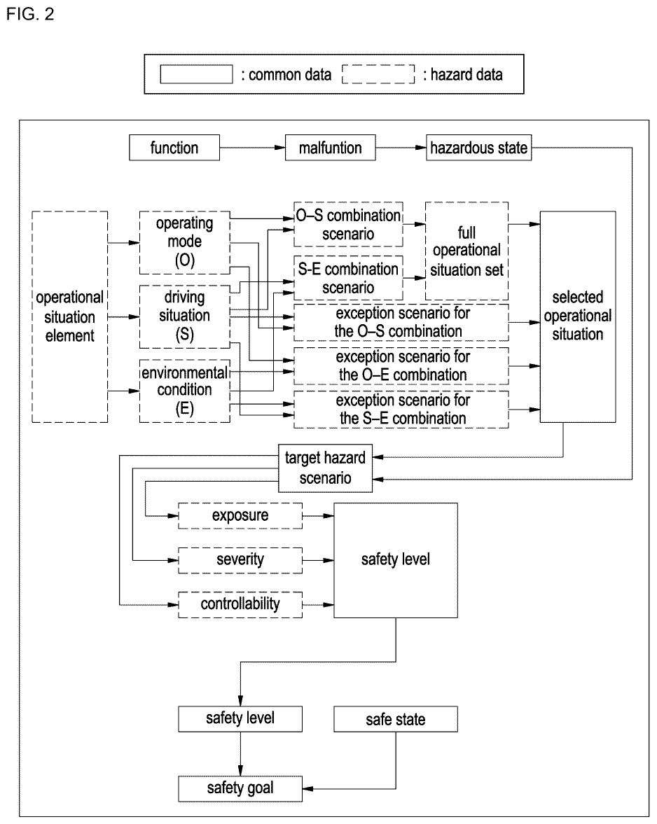

In an embodiment of the present invention, the respective steps of HAR A have interrelationships as shown in FIG. 2, and through this, the vehicle system can simultaneously consider both safety and security.

Furthermore, HARA includes procedures for evaluating each item of information and data based on the interconnected information and data.

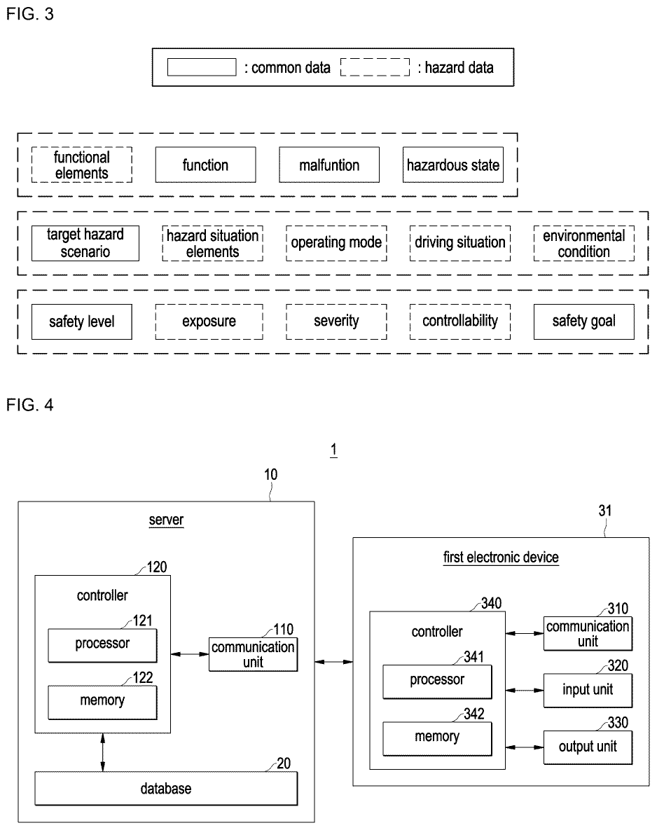

In addition, as illustrated in FIG. 2 and FIG. 3, HARA may be classified into common information and/or data that may be commonly applied and generalized between HARA and TARA, and HARA-specific information and/or data that are specialized for HARA, and such classification may be predefined.

FIG. 2 is a diagram illustrating a procedure and relational flow of safety hazard analysis and risk assessment according to an embodiment.

As shown in FIG. 2, the vehicle risk analysis procedure according to an embodiment includes a data-flow structure for establishing a safety goal based on the analysis results of the vehicle's functional safety (HARA; Hazard Analysis and Risk Assessment).

In FIG. 2, the data flow shown on the left corresponds to HARA, which is the functional safety analysis procedure, and the data-analysis flow is classified into common data and hazard data, which may form mutual reference and linkage relationships.

In HARA, data related to the vehicle's function, malfunctions of the function, and hazardous states that may occur due to the malfunctions are defined as hazard data. HARA performs hazard evaluation based on the causal relation ships among these elements. The vehicle functions may correspond to the ass et functions used in the TARA procedure described later.

For example, one of the major functions of a vehicle, the “Requesting acceleration” function, is configured to control the vehicle's driving torque according to the driver's pedal input signal. However, if the function does not operate normally and instead a malfunction occurs in which excessive acceleration torque is requested beyond what is required, the vehicle may reach a state of unintended longitudinal acceleration, independent of the driver's intention.

Such a malfunction directly affects the driving stability of the vehicle and may be classified as a hazardous state that threatens the safety of the occupants. Accordingly, within the HARA procedure, the causal relationships among functions and the process of hazard propagation are analyzed to provide the foundational data for the hazard assessment performed in subsequent stages.

A target hazard scenario to be used as a hazard-assessment target may be derived based on at least one operational situation element. The target hazard scenario may be generated by modeling representative operational situations that may occur while the vehicle is being driven, and may be created by combining at least one operational situation element regarding an operating mode of the vehicle, a driving situation, and an environmental condition. The target hazard scenario may be derived by combining the operating mode, the operational situation, and the environmental condition of the vehicle, while excluding combinations that are mutually contradictory or unrealistic. For example, when the operating mode of the vehicle is “highway driving,” the driving situation is “accelerating while the preceding vehicle maintains the same speed,” and the environmental condition is “flat, paved dry asphalt road,” such a combination of elements may be derived as a realistic target hazard scenario for hazard assessment.

Referring to FIG. 2, at least two among the vehicle operating mode (O), the driving situation (S), and the environmental condition (E) may be combine d to construct a hazard scenario. For example, the overall operational situation may be derived by combining the operating mode (O) and the driving situation (S). The overall operational situation may also be derived by combining the driving situation (S) and the environmental condition (E).

The vehicle operating mode (O), driving situation (S), and environmental condition (E) may each act as an independent risk factor; however, in an actual driving environment, these elements may influence one another, and only certain combinations may constitute a realistic hazard scenario.

Accordingly, as illustrated in FIG. 2, the mutual controllability relationships among the operational situation elements may be defined as an operating mode-driving situation controllability relationship (Contr O-S), an operating mode-environmental condition controllability relationship (Contr O-E), and a driving-situation-environment-condition controllability relationship (Contr S-E).

Here, Contr O-S is a relationship for verifying the combinability between the vehicle operating mode and the driving situation. For example, when a “highway autonomous-driving mode” is combined with a “preceding vehicle accelerating” situation, the combination may be excluded from a hazard scenario because it does not constitute an actual hazardous condition even if it occurs.

Contr O-E is a relationship for evaluating the controllability between the vehicle operating mode and the environmental condition. For example, when the vehicle is in a situation of “decelerating at 1 g due to sudden braking” while an “icy road surface” is detected, the combination may be determined to be contradictory and unlikely to occur simultaneously, and thus may be excluded from the hazard scenario.

Contr S-E is a relationship for evaluating the controllability between the driving situation and the environmental condition. For example, when the vehicle is in a situation of “highway driving” and a “pedestrian crossing the roadway” is detected, the combination may be determined to be unrealistic, and may therefore be excluded from the hazard scenario.

Based on these mutual controllability relationships (Contr O-S, Contr O-E, Contr S-E), only combinations that may realistically occur in an actual driving environment are selected as selected operational situations, and the target hazard scenario may be derived by combining the selected operational situation with the vehicle's hazardous state. Through this process, combinations that are contradictory or unrealistic in an actual environment are excluded, thereby enabling a more reliable hazard assessment.

For example, when a vehicle is traveling straight at a speed of 80 km/h on a highway, the preceding vehicle is maintaining a constant speed, and the driver intends to accelerate, such conditions may be defined as a hazardous e vent in which unintended longitudinal acceleration can occur due to a malfunction of the acceleration request function. Thereafter, combinations of operational situation elements that are contradictory, such as a case in which the highway driving mode is set despite the road surface being unpaved or a case in which unintended acceleration occurs despite the driver's intention to decelerate, are excluded from the overall operational situations. By excluding such combinations that have a very low likelihood of occurring in real-world conditions, realistic selected operational situations and target hazard scenarios that can be reliably evaluated may be derived.

For the derived target hazard scenario, a safety level (ASIL) may be determined based on the exposure (E), severity (S), and controllability (C) of the hazard situation. The safety level may be derived by evaluating the exposure, severity, and controllability of the hazard situation according to predefined evaluation criteria and combining the evaluation results.

Specifically, in an embodiment of the present invention, the determination of the safety level may be performed based on the functional safety evaluation procedure defined in the ISO 26262 standard. The exposure (E) represents an indicator of the likelihood that a particular hazard situation will occur in an actual driving environment and may be calculated by comprehensively considering factors such as the vehicle's driving frequency, road conditions, climate conditions, and the driver's driving habits. For example, when the vehicle is driving on a highway under clear weather with a dry road surface, such conditions m ay be evaluated as a frequently occurring situation in real-world driving environments and may be classified as exposure class E4 (High probability situation).

Severity (S) is an indicator for evaluating the potential degree of harm to occupants, the vehicle, and surrounding objects when a hazardous situation actually occurs. Severity may be derived by considering physical parameters such as the crash type, crash speed, crash side, initial distance, and acceleration. For example, when a vehicle traveling at the same speed as a preceding vehicle receives an excessive acceleration request signal from the rear and the distance between the vehicles rapidly decreases, a collision may occur, causing minor impact to the occupants. Such a situation may be evaluated as Severity S1 (minor injuries).

Controllability (C) is an indicator used to evaluate the driver's ability to perceive and avoid or control the hazard situation, and may be calculated by considering factors such as the driver's reaction time, driving skills, and whether a warning system is activated. For example, when the driver perceives the decreasing distance from the preceding vehicle and immediately releases the accelerator pedal or performs braking, the situation may be regarded as easily controllable by the driver and may be classified as controllability class C1 (simply controllable).

By combining the evaluation results of exposure (E), severity (S), and controllability (C) derived as described above, a safety level (ASIL) corresponding to the hazardous situation may be determined in an embodiment of the present invention. For example, when the situation is evaluated as E4 (high probability), S1 (minor severity), and C1 (simply controllable), the situation may be regarded as having relatively low risk and classified as QM (Quality Management).

The safety level determined as described above may be used as a reference value for defining the strength and scope of functional safety measures when e stablishing a safety goal.

According to an embodiment, a safety goal of the vehicle may be established based on the target hazard scenario and the safety level. Specifically, the safety goal according to this embodiment may be defined as a criterion for preventing, in advance, hazard situations that may occur due to a malfunction of a vehicle function, or for minimizing injury and system damage even if such a hazard occurs.

The establishment of the safety goal may be based on the ASIL grade determined for each target hazard scenario, and stricter safety control and diagnostic requirements may be imposed as the ASIL grade increases. For example, when the “acceleration request function” of the vehicle malfunctions and an excessive acceleration torque is generated beyond the driver's intention, the corresponding target hazard scenario may be defined as “unintended longitudinal acceleration.” In this case, based on the determined ASIL grade, safety goals such as the following may be established. For example, when unintended acceleration is detected, the safety goal may require that the acceleration control sign al be immediately cut off within 500 ms. Additionally, in the same situation, a notification function for promptly informing the driver and the relevant vehicle control modules (for example, an ECU) of the hazard occurrence may be included in the safety goal. Furthermore, when unintended acceleration is detected, the vehicle may automatically transition to a mitigation mode in which deceleration or functional limitation is applied, and the safety goal may specify that addition al fallback control measures be executed, such as pressure limitation, deactivation of related functions, or alternative control.

To achieve the safety goal, a fault tolerance time interval and a safe state may be defined for each vehicle function. For example, for the acceleration control function, the fault tolerance time interval may be set to 500 ms. In this case, when an abnormal torque is detected within the specified time, the system may immediately output a warning signal to the driver and cut off the acceleration control signal through the vehicle control module, thereby transitioning the vehicle to the safe state.

The safety goal established as described above may serve as a top-level requirement for ensuring the functional safety of the vehicle control system and may provide the basis for designing detailed diagnostic logic, error detection algorithms, and fail-safe mechanisms in subsequent development stages. In the system according to an embodiment of the present invention, the common data serves as key reference data for linking functional safety analysis (HARA) and cybersecurity analysis (TARA), and ensures data consistency and analytical continuity between the two assessment frameworks.

Specifically, the common data may include information such as the function of the vehicle, malfunctions of the function, assets, functions of the assets, and properties of the assets. Such common data may be used as input values for hazard evaluation at the functional level in the context of HARA. That is, the same system component may be defined as a function in HARA and evaluated as an element capable of causing a hazardous event, whereas in TARA, the same element may be defined as an asset and analyzed as a target expo sed to external attack threats. For example, a functional malfunction defined in HARA and an asset threat defined in TARA may be cross-referenced and linked to each other based on the same functional element through the common data.

In this manner, the common data functions as a data bridge that links the analytical results of functional safety and cybersecurity, thereby enabling cross-reference and integrated evaluation between the two analytical procedures.

FIG. 3 is a diagram exemplarily illustrating safety hazard analysis and risk-assessment data according to the embodiment of FIG. 2.

Referring to FIG. 3, information and/or data required to establish a safety goal for vehicle risk are shown. In FIG. 3, the data used to establish the safety goal may be referred to as hazard data, which may be HARA-specific data. In addition, the hazard data and threat data, that is, the data commonly referenced by both HARA and TARA, may be referred to as common data.

The hazard data referenced only in HARA may include information regarding the plurality of functional elements. The plurality of functional elements may include sub-data relating to the vehicle functions, malfunctions of the functions, and hazardous states that may occur due to the malfunctions. In this case, the data relating to the vehicle functions, functional malfunctions, and hazardous states may be the common data referenced by both HARA and TARA.

The common data regarding the target hazard scenario may be derived as hazard data referenced in HARA, based on a combination of data regarding the operational situation elements, the operating mode of the vehicle, the driving situation, and the environmental conditions. For example, the operational situation element defines the type of hazard that may occur when a malfunction of a function of the vehicle occurs, the operating mode of the vehicle distinguishes the driving state in which the function is performed, and the driving situation and the environmental conditions determine the level of risk according to external environmental factors. Through the combination of these factors, a target hazard scenario that may occur under specific operating conditions may be derived.

The common data relating to the safety level may correspond to data regarding the ASIL (Automotive Safety Integrity Level). For example, the safety level may be determined based on data relating to the exposure of the hazardous situation, the severity of the hazardous situation, and the controllability of the hazardous situation. Here, the data relating to exposure, severity, and controllability may correspond to hazard data referenced only in HARA. The safety goal may be derived based on the safety-level data, which is the common data referenced in both HARA and TARA.

FIG. 4 is a block diagram of a vehicle risk management system according to an embodiment.

Referring to FIG. 4, the server 10 of the vehicle risk management system 1 may include a database 20, a communication module 110, and/or a controller 340.

The database 20 may store information and/or data required to establish a safety goal for vehicle risk. For example, the data used to establish the safety goal may be referred to as hazard data. The hazard data may be HARA-exclusive data or data commonly referenced by both HARA and TARA.

The database 20 may store at least some of the preset plurality of hazard data required for performing HARA during the vehicle risk-management process. For example, the database 20 may store HARA-exclusive data. The HARA-exclusive data may be composed of a plurality of data items that represent respective sequential steps of a preset HARA procedure. The HARA-exclusive data may also include at least one piece of sub-data.

The database 20 may store a preset plurality of common data that are commonly referenced in both the HARA process and the TARA process. For example, the database 20 may store the common data illustrated in FIGS. 2 and 3, which are referenced in both HARA and TARA.

Meanwhile, at least some of the hazard data, its sub-data, and the common data may have a hierarchical structure, in which the data are dependent on or linked to one another, such that a modification or update of specific data may trigger a corresponding update of related data.

The database 20 may store connection-relationship information that defines hierarchical relationships among the HARA-exclusive data, that is, the hazard data according to the sequential phases of HARA.

The database 20 may store connection-relationship information that represents the stepwise or hierarchical relationships among the common data commonly referenced in both HARA and TARA.

The database 20 may store information representing interlinking relationships between the hazard data and the common data. For example, the database 20 may store linkage relationship information that allows at least one piece of HARA-exclusive data and one piece of common data referenced by both HARA and TARA to have a hierarchical reference relationship.

The communication unit 110 may establish a communication channel between the server 10 and external devices, for example the first through fifth electronic devices 31, 32, 33, 34, and 35 illustrated in FIG. 1, and may transmit and receive data through the established communication channel. The communication unit 110 may include a communication circuit and a control circuit configured to control the operation of the communication circuit in order to support such communication functions.

For example, the communication unit 110 may include a wireless communication module such as a cellular communication module, a Wi-Fi communication module, a short-range wireless communication module, or a global navigation satellite system communication module, and/or a wired communication module, and may transmit and receive data with external devices through the corresponding module.

The controller 120 may be electrically connected to each component of the server 10, for example the database 20 and the communication unit 110, and may control each component.

The controller 120 may control the HARA-exclusive data and the common data referenced by both HARA and TARA to be stored in the database 20.

The controller 120 may be communicatively connected to the electronic devices 31, 32, 33, 34, and 45 through the communication unit 110. Although only one first electronic device 31 is illustratively shown in FIG. 4, this is merely for explanation, and the capability to communicate with multiple electronic devices does not limit the scope of the present invention.

The controller 120 may receive a user ID from the first electronic device 31 and may set and assign user permissions for the electronic device 31 based on the received user ID.

The controller 120 may receive evaluation target information corresponding to a vehicle asset or vehicle function from the first electronic device 31 through the communication unit 110.

The controller 120 may generate and output HARA result data for the evaluation target information in response to receiving the evaluation target information, based on the HARA-exclusive data and/or the common data referenced by both HARA and TARA.

The controller 120 may generate HARA result data for the evaluation target information based on user input information (also referred to as user data) for at least a portion of the HARA-exclusive data and/or the common data referenced by both HARA and TARA, the user input information having been received through the communication unit 110. For example, the user input information may include user-defined values, that is, parameters for the corresponding data. The controller 120 may generate the HARA result data corresponding to the evaluation target information based on a designated HARA template (for example, a dynamic template) stored in the memory 122. The generated HARA result data may be transmitted to the first electronic device 31 through the communication unit 110.

The controller 120 may identify data, among the HARA result data, that is predetermined to be included in an FSM document, and may generate FSM document data based on a designated FSM template (for example, a dynamic template) stored in the memory 122. The generated FSM document data may also be transmitted to the electronic device 31 through the communication unit 110.

The controller 120 may include a control circuit configured to control the performance of the above functions.

The controller 120 may be implemented as a micro control unit (MCU) and may include the memory 122 and a processor 121.

The memory 122 may store programs and/or data for processing each piece of data (for example data received from external devices such as the first through fifth electronic devices 31, 32, 33, 34, and 35 shown in FIG. 1).

The memory 122 may temporarily store each piece of data or may temporarily store the processing result of data processed by the processor 121.

The memory 122 may include volatile memory such as S-RAM or D-RAM as well as non-volatile memory such as flash memory, ROM, EPROM, and/or EEPROM.

The processor 121 may process each piece of received data and may output signals for controlling the communication unit 110 and/or the database 20 based on the processing result.

The first electronic device 31 may include a communication unit 310, an input unit 320, an output unit 330, and a controller 340.

The communication unit 310 may establish a communication channel between the first electronic device 31 and an external device, for example the server 10, and may transmit and receive data through the established communication channel. The communication unit 310 may include a communication circuit and a control circuit configured to control operation of the communication circuit.

For example, the communication unit 310 may include a wireless communication module such as a cellular communication module, a Wi-Fi communication module, a short-range wireless communication module, or a global navigation satellite system communication module, and/or a wired communication module, and may transmit and receive data with an external device through the corresponding communication module.

The input unit 320 may receive information according to a user operation and may provide the information to a connected device such as the controller 340.

For example, the input unit 320 may include input means such as buttons, switches, a touchscreen, and/or a microphone.

The output unit 330 may output visual and/or auditory information so that a user of the first electronic device 31 can perceive the information. For example, the output unit 330 may include a display and/or a speaker.

The controller 340 may be electrically connected to each component of the first electronic device 31, for example the communication unit 310, the input unit 320, and/or the output unit 330, and may control operations of the respective components.

The controller 340 may communicate with the server 10 through the communication unit 310. The controller 340 may receive a service for managing HARA documents from the server 10 through the communication unit 310.

For example, the controller 340 may receive at least a portion of the HARA-exclusive data and/or the common data referenced by both HARA and TARA from the server 10, and may output the received data through the output unit 330, for example, a display.

The controller 340 may acquire evaluation target information corresponding to a vehicle asset or function according to a user operation through the input unit 320.

The controller 340 may acquire user input information, such as parameters, through the input unit 320 for at least a portion of the HARA-exclusive data and/or the common data referenced by both HARA and TARA.

The controller 340 may transmit the user input information acquired through the input unit 320 for at least a portion of the HARA-exclusive data and/or the common data referenced by both HARA and TARA to the server 10 through the communication unit 310.

The controller 340 may receive HARA result data for the evaluation target information from the server 10 through the communication unit 310, and may output the received result data to the user through the output unit 330, for example, a display.

In addition, the controller 340 may receive result data for the FSM document from the server 10 through the communication unit 310 and may output the data through the output unit 330, for example a display.

Meanwhile, the controller 340 may include a control circuit.

The controller 340 may be implemented as a micro control unit (MCU; Micro Control Unit) and may include a memory 342 and/or a processor 341.

The memory 342 may store programs and/or data for processing each piece of data, for example data received from an external device such as the server 10 or data corresponding to information input through the input unit 320.

The memory 342 may temporarily store received data or may temporarily store results of data processed by the processor 341.

The memory 342 may include volatile memory such as S RAM and/or D RAM, and non volatile memory such as flash memory, ROM (Read Only Memory), EPROM (Erasable Programmable Read Only Memory), and/or EEPROM (Electrically Erasable Programmable Read Only Memory).

The processor 341 may process each received or input piece of data and may provide control signals to the respective components in order to control the communication unit 310, the input unit 320, and the output unit 330 based on the processing result.

Although not shown in FIG. 4, the second electronic device 32, the third electronic device 33, the fourth electronic device 34, and the fifth electronic device 35 of FIG. 1 may include a communication unit, an input unit, an output unit, and a controller similar to those of the first electronic device 31, and may perform operations similar to those of the first electronic device 31.

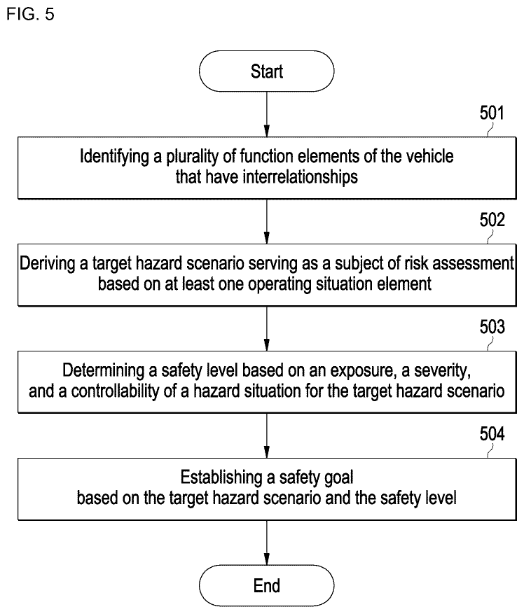

FIG. 5 is a flowchart illustrating a control operation procedure of a server according to an embodiment.

Referring to FIG. 5, the server may identify a plurality of functional elements of the vehicle that have interrelationships (501).

According to an embodiment, the plurality of functional elements may be HARA related data concerning functional safety and may include at least one of the vehicle function, a malfunction of the function, and a hazardous state caused by the malfunction. Here, the data regarding the vehicle function, the malfunction of the function, and the hazardous state that may occur due to the malfunction may be data commonly referenced by both HARA and TARA.

The server may derive a target hazard scenario, which serves as an evaluation target for risk assessment, based on at least one operational situation element (502). For example, the target hazard scenario may be derived by modeling representative operational situations that may occur during vehicle driving. In one embodiment, the target hazard scenario may be derived by combining at least one operational situation element relating to the vehicle's operating mode, driving situation, and environmental condition, and by excluding contradictory combinations among the combined operational situation elements. The target hazard scenario may be defined as a hazardous event formed by a combination of the operational situation and the hazardous state. For the combinations and exclusion rules among the operating mode, driving situation, and environmental condition, reference is made to the description of FIG. 2 above.

The server may determine a safety level based on the exposure, severity, and controllability of the hazard for the target hazard scenario (503). For the derived target hazard scenario, the safety level (ASIL) may be determined based on the exposure E, severity S, and controllability C of the hazard. In one embodiment, the safety level may be determined by evaluating the exposure, severity, and controllability of the hazard according to predefined evaluation criteria, and by combining the evaluation results.

The server may establish a safety goal based on the target hazard scenario and the safety level (504). Specifically, in the present embodiment, the safety goal may be established as a criterion for preventing hazardous situations that may occur due to malfunctions of vehicle functions in advance, or for minimizing injury to persons and damage to the system even if such hazards occur.

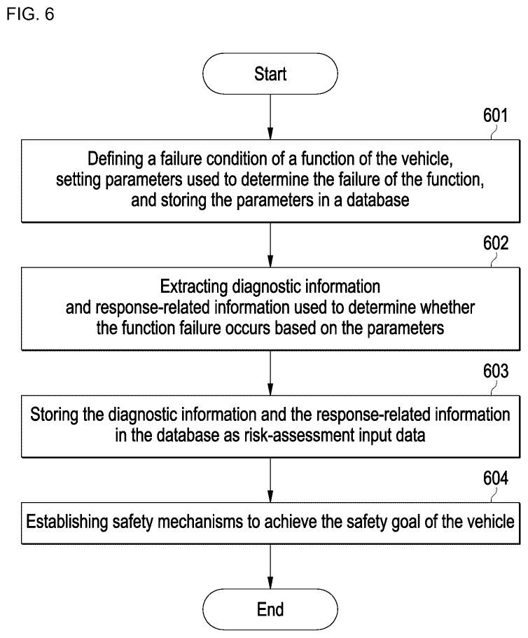

FIG. 6 is a flowchart illustrating a control procedure of a server for achieving a safety goal of a vehicle according to an embodiment.

The server may define a failure condition of a function of the vehicle and set parameters used to determine the failure of the function, and store the parameters in the database (601). For example, the server may set various diagnostic data such as sensor input values, control command signals, system response latency, temperature, and voltage as the parameters, and use them to determine whether the function is operating normally.

The server may extract diagnostic information and response-related information used to determine the failure of the function of the vehicle based on the parameters used for determining the failure (602). The server may configure diagnostic logic by referring to the threshold values of the parameters, normal operating ranges, and failure occurrence conditions, and define response steps to be applied when a failure occurs, such as providing a warning, limiting a function, or switching to a protective mode, thereby establishing reference information required for managing functional failures of the vehicle.

The server may store the diagnostic information and response-related information associated with the functional failure of the vehicle in the database and use them as risk assessment input data (603). The server may structure and store in the database various forms of analysis data, including failure determination results, failure occurrence time, frequency, state information, response steps performed, and effectiveness of the response, which are derived through the diagnostic information of step 602. Accordingly, the server may support the use of the analyzed data as reliable reference materials during risk assessment related to vehicle safety. That is, information such as the cause of each functional failure, its frequency, and the effectiveness of applied countermeasures may be reflected in the risk level assessment during a subsequent HARA analysis.

The server may establish safety mechanisms for achieving the safety goal of the vehicle (604). For example, the server may define a safety mechanism composed of a failure detection logic, rules for switching to a protective mode, a safety diagnostic cycle, and signal monitoring conditions, and may deploy or update the safety mechanism in association with a vehicle controller or a network gateway. In addition, the server may automatically adjust or refine parameters of the safety mechanism based on real-time operational data and diagnostic information collected from the vehicle to ensure that the vehicle system stably maintains the safety goal.

In one embodiment, for the same or similar target hazard scenarios, the server may match the application results of the safety mechanisms and manage them in an integrated manner within the database.

In the foregoing embodiments, a unified procedure has been presented to establish a framework that enables risk management activities to be performed without information omission. This framework provides the effect of eliminating resource waste and duplication that may occur when functional safety assessments are performed and managed separately. Through the example of a vehicle braking system, it has been confirmed that the efficiency of the risk management procedure can be improved.

In addition, the foregoing embodiments focus on identifying the relationships among data centered on a HARA analysis and unifying risk mitigation activities through the identified safety mechanisms. However, the quality of the results of risk mitigation activities may vary depending on the level of detail in the design and analysis. Therefore, the framework described in the foregoing embodiments may be extended to incorporate tools such as fault tree analysis and failure mode and effects analysis to further support the functional safety analysis.

Meanwhile, in the foregoing embodiments, common elements between TARA and HARA have been identified to enable the identification of predictable risks related to functional safety and asset protection in vehicle operation and to support the execution of activities for mitigating such risks. Furthermore, a unified procedure has been presented to ensure that risk management activities can be conducted without information omission. This framework provides the effect of eliminating resource waste and duplication that may occur when functional safety activities are performed and managed independently. Through the example of a vehicle braking system, it has been verified that the efficiency of the risk management procedure can be enhanced. In particular, in the embodiment of FIG. 6, a foundational recursive analysis starting from the item definition has been applied, thereby providing a basis for establishing optimization strategies for risk management throughout the vehicle lifecycle. The utilization of such a framework is expected to reduce development costs and improve quality, which in turn may lead to a reduction in quality-related costs. Ultimately, this can contribute to improving corporate productivity and enhancing long-term sustainability.

Furthermore, the foregoing embodiments clarify the sequence of procedures within the HARA process and emphasize the unification of risk mitigation activities through the identified new security controls and safety mechanisms. However, the quality of risk mitigation outcomes depends on the level of detail in design and analysis. Accordingly, the framework described in the foregoing embodiments may be expanded to incorporate tools such as fault tree analysis and failure mode and effects analysis for diagnosing functional safety.

In another aspect, the disclosed embodiments may be implemented in the form of a recording medium storing instructions that are executable by a computer. The instructions may be stored as program code and, when executed by a processor, may generate program modules that perform the operations of the disclosed embodiments.

The recording medium may be implemented as a computer-readable recording medium.

The computer-readable recording medium includes any type of medium in which instructions that can be interpreted by a computer are stored. Examples include read only memory (ROM), random access memory (RAM), magnetic tapes, magnetic disks, flash memory, and optical data storage devices.

The machine-readable storage medium may be provided as a non-transitory storage medium. The term “non-transitory” merely indicates that the storage medium is a tangible device that does not include signals such as electromagnetic waves, and does not distinguish whether data is stored permanently or temporarily. For example, a non-transitory storage medium may include a buffer in which data is stored temporarily.

The disclosed embodiments have been described above with reference to the accompanying drawings. It will be understood by those skilled in the art that various modifications and other embodiments may be made without departing from the technical spirit or essential characteristics of the present invention. The disclosed embodiments are therefore to be regarded as illustrative and not restrictive.

1. A vehicle risk management method comprising:
identifying a plurality of function elements of the vehicle that have interrelationships;
deriving a target hazard scenario serving as a subject of risk assessment based on at least one operational situation element;
determining a safety level based on an exposure, a severity, and a controllability of a hazard situation for the target hazard scenario; and
establishing a safety goal based on the target hazard scenario and the safety level.

2. The method of claim 1,
wherein the plurality of function elements includes at least one of a function of the vehicle, a malfunction of the function, and a hazardous state that may occur due to the malfunction.

3. The method of claim 2,
wherein the target hazard scenario is derived based on a driving situation obtained by combining the at least one operational situation element related to an operating mode, a driving situation, and an environmental condition of the vehicle, and excluding contradictory combinations among the combined operational situation elements.

4. The method of claim 3,
wherein the target hazard scenario is defined as a hazardous event formed by a combination of the operational situation and the hazardous state.

5. The method of claim 1,
wherein the safety level is determined by evaluating the exposure, the severity, and the controllability of the hazard situation according to predetermined evaluation criteria, and combining evaluation results of the exposure, the severity, and the controllability.

6. The method of claim 1,
further comprising establishing safety mechanisms to achieve the safety goal of the vehicle,
wherein establishing the safety mechanisms comprises:
defining a failure condition of a function of the vehicle, setting parameters used to determine the failure of the function, and storing the parameters in a database; and
extracting diagnostic information and response-related information used to determine whether the function failure occurs based on the parameters, and storing the diagnostic information and the response-related information in the database as risk-assessment input data.

7. The method of claim 6,
wherein, for identical or similar target hazard scenarios, results of applying the safety mechanisms are matched with each other and are linked or managed in the database.

8. A computer program stored on a medium for causing a computing device to execute the method according to claim 1.

9. A database storing a plurality of data for vehicle risk management;
a communication module configured to communicate with an external device; and
a processor electrically or communicatively connected to the database and the communication module,
wherein the processor is configured to:
identify a plurality of function elements of the vehicle that have interrelationships;
derive a target hazard scenario that is a subject of risk assessment based on at least one operational situation element;
determine a safety level based on an exposure, a severity, and a controllability of a hazard situation for the target hazard scenario; and
establish a safety goal based on the target hazard scenario and the safety level.

10. The server of claim 9,
wherein the plurality of function elements include at least one of a function of the vehicle, a malfunction of the function, and a hazardous state that may occur due to the malfunction.

11. The server of claim 10,
wherein the target hazard scenario is derived by combining the at least one operational situation element regarding an operating mode, a driving situation, and an environmental condition of the vehicle, and excluding contradictory combinations among the combined operational situation elements.

12. The server of claim 11,
wherein the target hazard scenario is defined as a hazardous event formed by combining the operational situation and the hazardous state.

13. The server of claim 9,
wherein the safety level is determined by evaluating the exposure, severity, and controllability of the hazard situation based on predetermined evaluation criteria, and combining results of the evaluations of the exposure, the severity, and the controllability.

14. The server of claim 9,
wherein the processor is configured to establish a safety mechanism for achieving the safety goal of the vehicle, and
to define a functional failure condition of the vehicle, set a parameter used for determining the functional failure, store the parameter in the database, extract diagnostic information and response-related information used for determining whether a functional failure of the vehicle has occurred based on the parameter, and store the diagnostic information and the response-related information in the database as risk-assessment input data, thereby establishing the safety mechanism.

15. The server of claim 14,
wherein the processor is configured such that, for identical or similar target hazard scenarios, results of applying the safety mechanism are matched with each other and linked or managed in the database.
